(19) United States
(12) Patent Application Publication
(10) Pub. No.: US 2016/0147313 A1
(43) Pub. Date: May 26, 2016

(54) Mobile Terminal and Display Orientation Control Method

(71) Applicant: KYOCERA Corporation, Kyoto-shi (JP)

(72) Inventor: Takashi HIGASHITANI, Amagasaki-shi (JP)

(73) Assignee: KYOCERA Corporation

(21) Appl. No.: 15/010,294

(22) Filed: Jan. 29, 2016

Related U.S. Application Data
(63) Continuation of application No. PCT/JP2014/069930, filed on Jul. 29, 2014.

(30) Foreign Application Priority Data
Jul. 29, 2013 (JP) 2013-156245

(51) Int. Cl. G06F 3/038; G09G 5/38; G06T 3/60; G06F 3/0488; G06F 3/041; G06F 3/0346

(52) U.S. Cl. CPC G06F 3/038; G06F 3/0412; G06F 3/0346; G06T 3/60; G06F 3/04883; G09G 5/38; G06F 2203/04104; G09G 2354/00; G09G 2340/0492

(57) ABSTRACT

A mobile terminal has a touch screen and a sensor configured to sense a change of an orientation of this mobile terminal. CPU of this mobile terminal is configured to, when the sensor senses a change of the orientation of the mobile terminal, determine whether or not a two-point long touch operation is being performed on the touch screen. CPU is configured to, when it is determined that a two-point long touch operation is not being performed, turn a display orientation of an image based on a sensing result of the sensor. CPU is configured to, when it is determined that a two-point long touch operation is being performed, forbid such turning until the orientation of the mobile terminal is changed next time.

### CROSS-REFERENCE TO RELATED APPLICATION

The present application is a continuation based on PCT Application No. PCT/JP2014/069930 filed on Jul. 29, 2014, which claims the benefit of Japanese Application No. 2013-156245, filed on Jul. 29, 2013. PCT Application No. PCT/JP2014/069930 is entitled “Mobile Terminal and Display Direction Control Method”, and Japanese Application No. 2013-156245 is entitled “Mobile Terminal, and Display Direction Control Program and Method.” The content of which are incorporated by reference herein in their entirety.

### FIELD

The present disclosure relates to a mobile terminal and a display orientation control method of sensing the orientation of a screen by a sensor and turning the display orientation of an image with respect to a screen.

### BACKGROUND

Generally, in a mobile terminal that can be held vertically and laterally, display orientation control of sensing the orientation of the mobile terminal by a sensor, such as an accelerometer, and turning the display orientation of an image such that the image can be seen upright for a user in either way of holding is performed.

When a user sees an image on the mobile terminal while lying down, the orientation of the mobile terminal is sensed as being lateral by a sensor, but remains vertical for the user. With the display orientation control, the image will be displayed in an orientation that the user does not intend.

There is a mobile electronic apparatus that switches between a standby mode and a hold mode based on a detection result of an accelerometer.

### SUMMARY

A mobile terminal of an embodiment includes a touch screen, a sensor, a storage unit, and at least one processor. The touch screen is configured to display an image and receive a touch operation relevant to the image. The sensor is configured to sense a change of an orientation of the mobile terminal. When the sensor senses the change of the orientation of the mobile terminal, the at least one processor is configured to determine whether or not a specific touch operation is being performed on the touch screen. The at least one processor is configured to turn a display orientation of the image based on a sensing result of the sensor when it is determined that the specific touch operation is not being performed. The at least one processor is configured not to turn the display orientation of the image when it is determined that the specific touch operation is being performed.

A display orientation control method of an embodiment is configured to control a display orientation of an image displayed on a touch screen of a mobile terminal. The touch screen is configured to display the image and receive a touch operation relevant to the image. The display orientation control method comprises sensing, determining, turning and not turning. The display orientation control method is configured to sense a change of an orientation of the mobile terminal. When the change of the orientation of the mobile terminal is sensed, it is determined whether or not a specific touch operation is being performed on the touch screen. When it is determined that the specific touch operation is not being performed, a display orientation of the image is turned based on a sensing result. When it is determined that the specific touch operation is being received, the display orientation of the image is not turned.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram showing an electric configuration of a mobile terminal of an embodiment.

FIG. 2 is an illustration showing an appearance (a touch screen and keys operated by a user) of a mobile terminal.

FIG. 3A is an illustration of a user using a mobile terminal in the vertically-held state while remaining standing.

FIG. 3B is an illustration of a user using a mobile terminal in the vertically-held state while lying on the floor.

FIG. 4A is an illustration showing an example of display orientation control when a user lies down without a two-point long touch operation (or when a user changes the vertically-held state to the laterally-held state while remaining standing), representing a display mode of a touch screen before lying down (or while using the mobile terminal in the vertically-held state).

FIG. 4B is an illustration showing an example of display orientation control when a user lies down without a two-point long touch operation (or when a user changes the vertically-held state to the laterally-held state while remaining standing), representing a display mode of a touch screen after lying down (or while using the mobile terminal in the laterally-held state).

FIG. 5A is an illustration showing an example of display orientation control when a user lies down while performing a two-point long touch, then cancels the two-point long touch, and rises up again while performing a two-point long touch, representing a display mode of a touch screen before lying down.

FIG. 5B shows a display mode of the touch screen after the user lies down.

FIG. 5C shows a display mode of the touch screen when canceling a two-point long touch while lying down.

FIG. 5D shows a display mode of the touch screen before rising up again while performing a two-point long touch.

FIG. 5E shows a display mode of the touch screen after rising up.

FIG. 6A is an illustration showing an example of display control when a user lies down while performing a two-point long touch, and then rises up without a two-point long touch, representing a display mode of a touch screen before rising up.

FIG. 6B shows a display mode of the touch screen after rising up without a two-point long touch operation.

FIG. 7 illustrates a memory map showing the contents of a main memory of a mobile terminal.

FIG. 8 is a flowchart showing an example of a display orientation control process executed by CPU of a mobile terminal, and corresponding to FIGS. 4A to 6B.

FIG. 9 is an illustration showing transition of various flags stored in the main memory, and corresponding to FIGS. 4A to 6B.

FIG. 10A is an illustration showing a variation of display orientation control (FIGS. 6A and 6B) when a user lies down while performing a two-point long touch, and then rises up without a two-point long touch, representing a state of a touch screen before rising up without a two-point long touch operation.

FIG. 10B shows a state of the touch screen after rising up without a two-point long touch operation.

FIG. 11 is a flowchart showing a display orientation control process in a variation, and corresponding to FIGS. 4A to 5E and 10A, 10B.

FIG. 12 is an illustration showing flag transition in the variation, and corresponding to FIGS. 4A to 5E and 10A, 10B.

### DETAILED DESCRIPTION

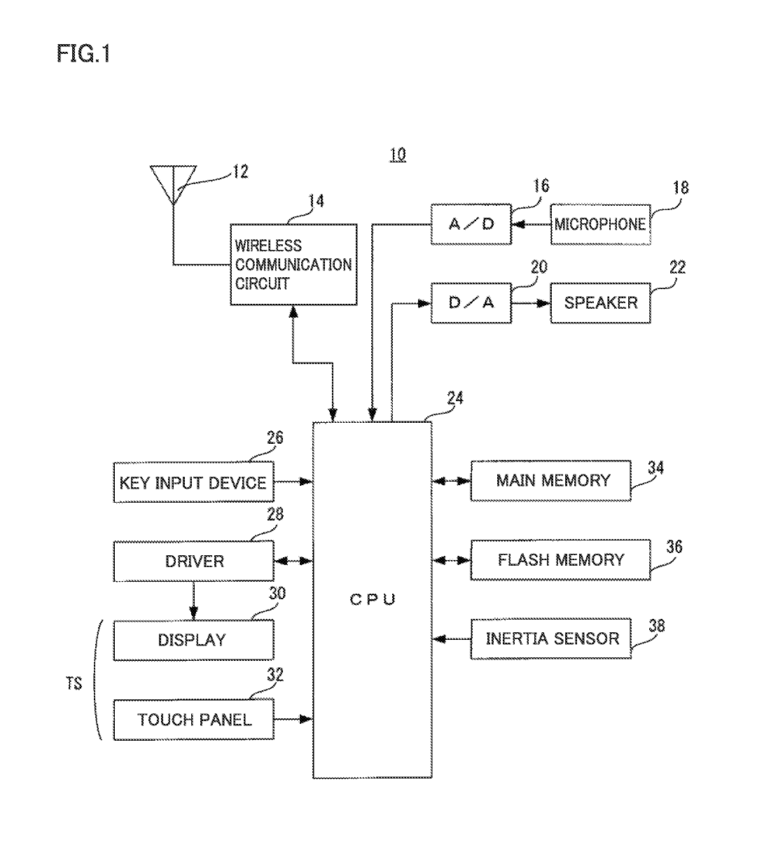

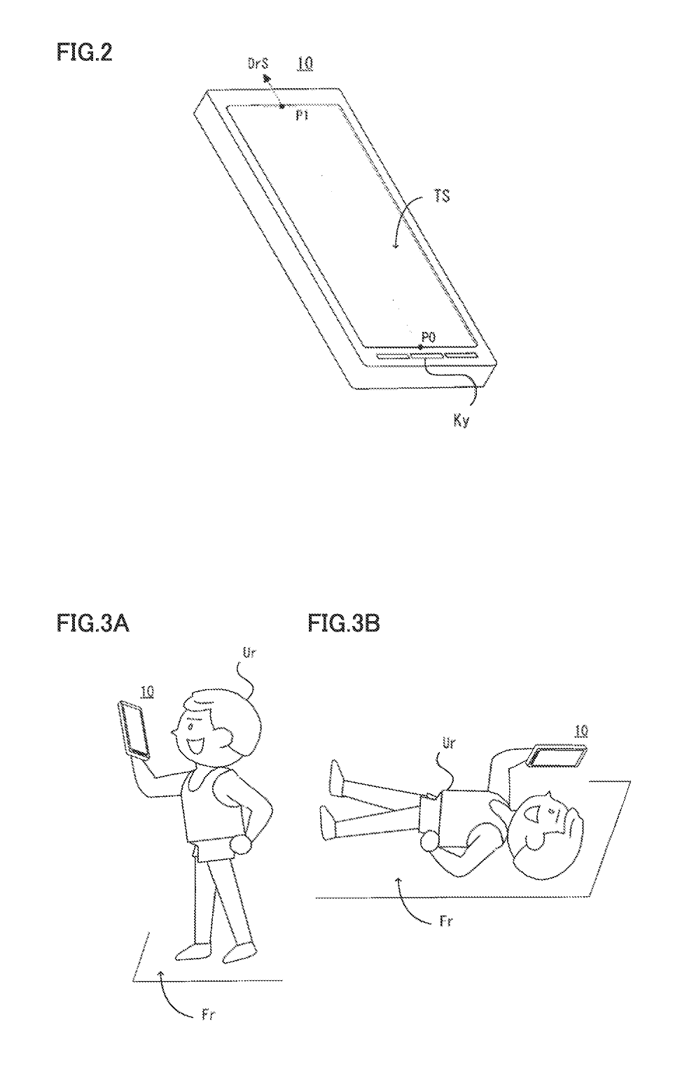

FIG. 1 shows a hardware configuration of a mobile terminal 10 according to an embodiment. FIG. 2 shows an appearance of mobile terminal 10. FIGS. 3A and 3B each show an example of use of mobile terminal 10 by a user Ur.

Referring to FIGS. 1, 2, 3A and 3B, mobile terminal 10 includes a CPU 24. Connected to CPU 24 are a key input device 26, a touch panel 32, a main memory 34, a flash memory 36, and an inertia sensor 38. To CPU 24, an antenna 12 is connected through a wireless communication circuit 14, a microphone 18 is connected through an A/D converter 16, a speaker 22 is connected through a D/A converter 20, and a display 30 is connected through a driver 28.

Antenna 12 can acquire (receive) a radio signal from a base station not shown, and can emit (transmit) a radio signal from wireless communication circuit 14. Wireless communication circuit 14 can demodulate and decode a radio signal received by antenna 12, and can code and modulate a signal from CPU 24. Microphone 18 can convert an acoustic wave into an analog audio signal. A/D converter 16 can convert the audio signal from microphone 18 into digital audio data. D/A converter 20 can convert the audio data from CPU 24 into an analog audio signal. Speaker 22 can convert the audio signal from D/A converter 20 into an acoustic wave.

Key input device 26 is implemented by various types of keys (Ky: FIG. 2), buttons (not shown) and the like operated by a user, and can input a signal (command) in accordance with an operation to CPU 24. Frequently used functions, such as “displaying a home (standby) image”, “displaying a menu image” and “return”, are assigned to keys Ky.

Driver 28 can cause display 30 to display an image in accordance with a signal from CPU 24. Touch panel 32 may be located on the display surface of display 30, and can input a signal (X and Y coordinates) indicating the position of a touch point to CPU 24. For example, with a standby image (not shown) being displayed on display 30, when a user performs an operation of touching any item (icon) in the standby image, the coordinates of the touch point may be detected by touch panel 32. CPU 24 can distinguish which item has been selected by a user.

Hereinafter, display 30 with touch panel 32 having the function of displaying an image and receiving a touch operation thereon as described above will be referred to as a “touch screen” (TS: FIG. 2) as appropriate. The orientation from a central point P0 of the lower edge of touch screen TS (the edge on the side of keys Ky) toward a central point P1 of the upper edge is defined as an “orientation DrS of mobile terminal 10.”

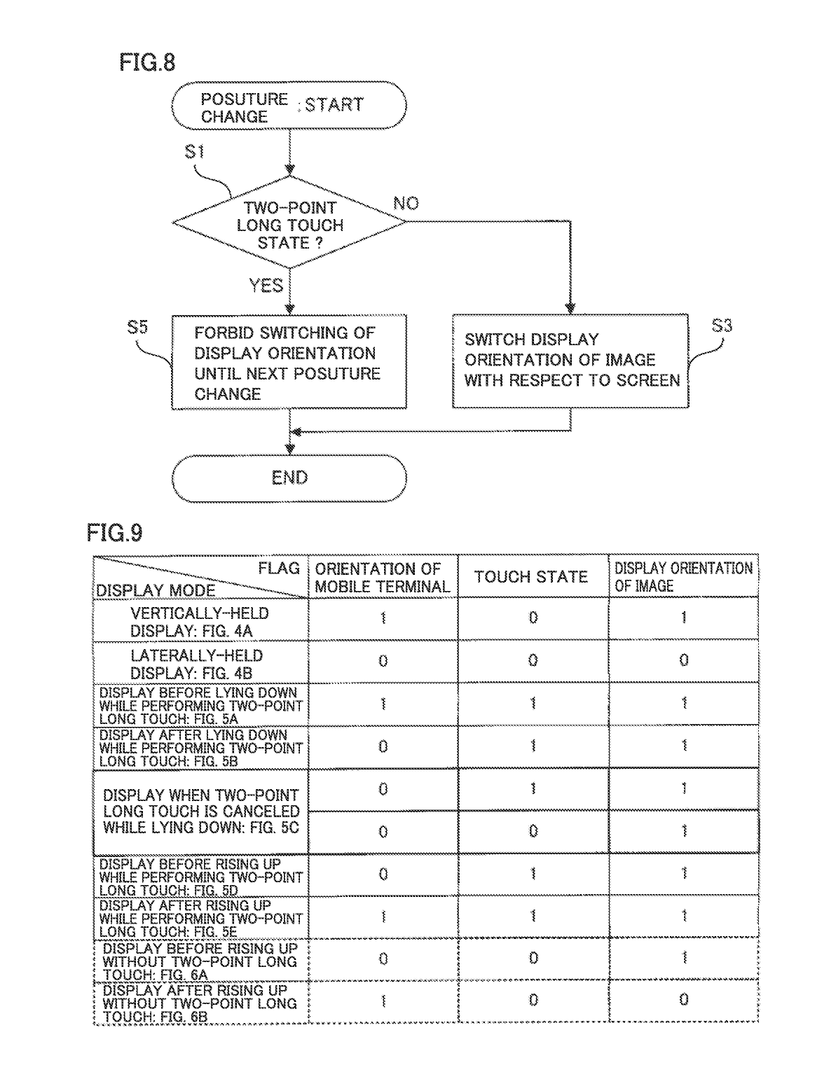

Main memory 34, implemented by an SDRAM or the like, for example, can store a program, data and the like (see FIG. 7) for causing CPU 24 to execute various types of processes and can provide a workspace necessary for CPU 24. Flash memory 36 may be implemented by a NAND type flash memory, for example, and may be utilized as an area for storing a program, data and the like.

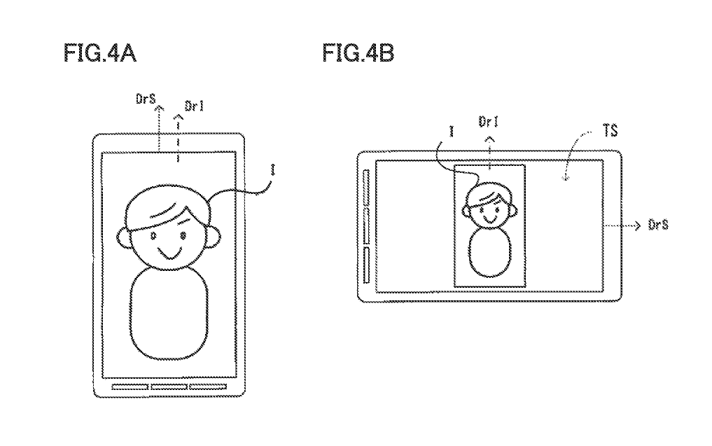

Inertia sensor 38 may be implemented by an accelerometer, a gyroscope and the like (a triaxial accelerometer and a gyroscope may be combined), for example, and can detect the orientation (DrS: see FIGS. 4A and 4B) of mobile terminal 10 and its change.

In accordance with programs (52 to 56) stored in main memory 34, CPU 24 can execute various types of processes while utilizing other pieces of hardware (12 to 22, 26 to 38).

In mobile terminal 10 configured as described above, by touching one of icons and menu items, neither shown but displayed on touch screen TS, a conversation mode of having a conversation, a data communication mode of making data communication, an application processing mode of executing application processing or the like can be selected.

When the conversation mode is selected, mobile terminal 10 can function as a communication device. Specifically, when a calling operation is performed with the ten key or the like displayed on touch screen TS, CPU 24 can control wireless communication circuit 14 and can output a calling signal. The output calling signal is output through antenna 12, and is transmitted to a partners telephone through a mobile communication network not shown. The partners telephone starts calling by a ringtone or the like. When a partner performs a call receiving operation, CPU 24 can start conversation processing. When a calling signal from a partner is acquired by antenna 12, wireless communication circuit 14 can notify call reception to CPU 24. CPU 24 can start calling by the ringtone from speaker 22, vibration caused by a vibrator not shown, or the like. When a call receiving operation is performed by a call receiving button or the like displayed on touch screen TS, CPU 24 can start conversation processing.

The conversation processing is performed as follows, for example. A received audio signal sent from a partner may be acquired by antenna 12, demodulated and decoded by wireless communication circuit 14, and then supplied to speaker 22 through D/A converter 20. Received voice is thus output through speaker 22. A transmitted audio signal captured through microphone 18 may be transmitted to wireless communication circuit 14 through A/D converter 16, coded and modulated by wireless communication circuit 14, and then transmitted to the partner through antenna 12. The partner's telephone also demodulates and decodes the transmitted audio signal, and outputs transmitted voice.

When the data communication mode is selected, mobile terminal 10 functions as a data communication device. Specifically, address information on a homepage to be displayed initially is stored in flash memory 36. CPU 24 can obtain hyper text data by making data communication with a server (not shown) on the Internet through wireless communication circuit 14, and can cause display 30 to display a homepage (HTML document) based on this data through driver 28. When any hyperlink included in the displayed homepage is selected by a touch operation, another homepage associated with this hyperlink is displayed.

When the application processing mode is selected, mobile terminal 10 functions as an information processing device that executes an application for image review or the like, for example. Specifically, image data extracted from the above-described homepage, image data picked up by a camera not shown, and the like are stored in flash memory 36. CPU 24 can obtain image data from flash memory 36, and can cause touch screen TS to display a list of thumbnail images thereof or to display an enlarged image corresponding to a selected thumbnail image.

With an image (I: see FIGS. 4A and 4B) of an application being displayed on touch screen TS, CPU 24 can perform control of turning the display orientation (DrI: see FIGS. 4A and 4B) of image I with respect to touch screen TS based on a sensing result of inertia sensor 38.

Specifically, when mobile terminal 10 is changed from the vertically-held state as shown in FIG. 4A to the laterally-held state as shown in FIG. 4B, CPU 24 can determine that orientation DrS of mobile terminal 10 has been changed from the vertical orientation to the lateral orientation based on the sensing result of inertia sensor 38. CPU 24 can turn display orientation DrI of image I to an orientation intersecting (typically, perpendicular or substantially perpendicular to) orientation DrS of mobile terminal 10. Through such display orientation control, even if user Ur holds mobile terminal 10 laterally, image I can be seen upright for user Ur.

When user Ur vertically holding mobile terminal 10 as shown in FIG. 3A lies on a floor Fr as shown in FIG. 3B while vertically holding mobile terminal 10, it is determined that orientation DrS of mobile terminal 10 has been changed from the vertical orientation to the lateral orientation, based on a sensing result of inertia sensor 38. Accordingly, display orientation DrI of image I is turned to the orientation that intersects orientation DrS of mobile terminal 10, as shown in FIG. 4B.

The body of user Ur is laterally oriented similarly to touch screen TS at this time, and as a result, image I is seen lying for user Ur. When user Ur laterally holding mobile terminal 10 lies down, inconvenience of the type similar to this also occurs. As a result that user Ur lies down, image I having been seen upright so far will be seen lying by the display orientation control, which may degrade visibility contrarily.

In an embodiment, when user Ur wishes to use mobile terminal 10 while lying down, he/she can perform a touch operation of touching touch screen TS with two fingertips simultaneously or substantially simultaneously before lying down and maintaining the two-point touch state during the action of lying down, and releasing the two-point touch state after lying down (referred to as a “two-point long touch operation”). Control can be exerted so as to forbid turning of image I with respect to touch screen TS.

When orientation DrS of mobile terminal 10 is changed, display orientation control of an embodiment can turn image I if touch screen TS is in a state other than a state in which the two-point long touch being operated (two-point long touch state). If touch screen TS is in the two-point long touch state, image I can be seen upright even when user Ur lies down, by forbidding turning of (fix) image I with a change of orientation DrS of mobile terminal 10 (i.e., a posture change of mobile terminal 10).

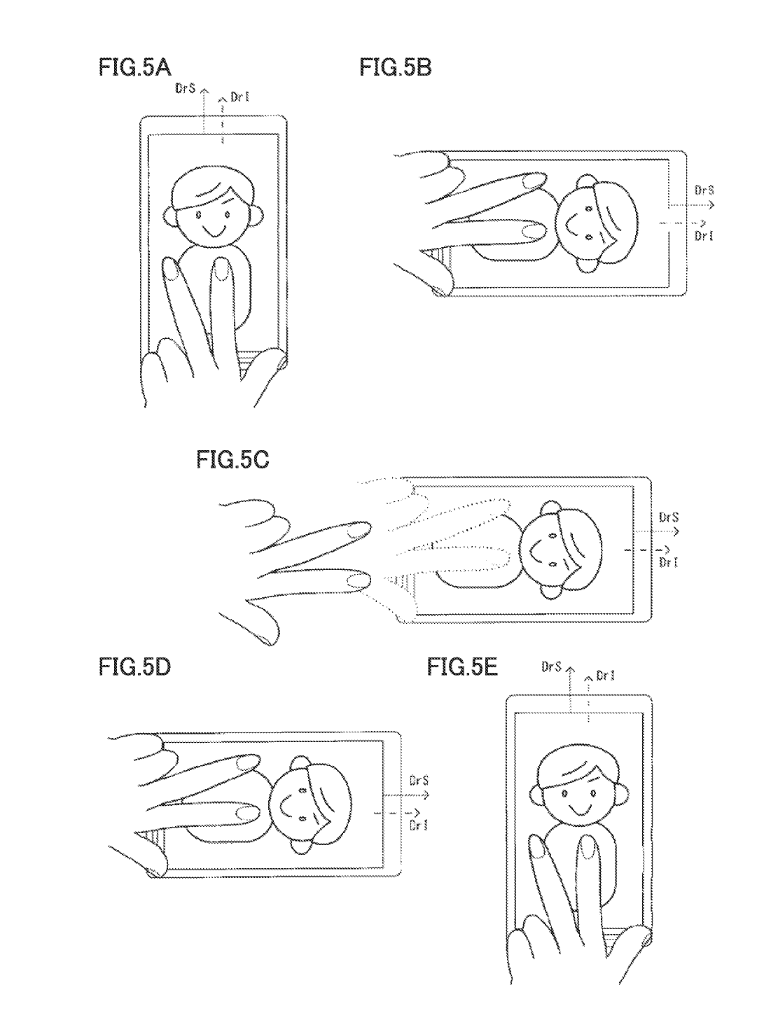

FIGS. 5A to 5E show examples of display orientation control when a user lies down while performing a two-point long touch operation, then cancels the two-point long touch operation, and rises up again while performing a two-point long touch operation. FIG. 5A shows a display mode of touch screen TS before lying down while making a two-point long touch. FIG. 5B shows a display mode of touch screen TS after lying down while making a two-point long touch. FIG. 5C shows a state of touch screen TS when canceling a two-point long touch after (in the state) lying down while making the two-point long touch. FIG. 5D shows a display mode of touch screen TS before rising up again while making a two-point long touch. FIG. 5E shows a display mode of touch screen TS after rising up while making a two-point long touch.

Referring to FIG. 5A, at first, as shown in FIG. 3A, user Ur stands (or sits) on floor Fr, and vertically holds mobile terminal 10 with his/her right hand. From a sensing result of inertia sensor 38, orientation DrS of mobile terminal 10 is determined as the vertical orientation. Display orientation DrI of image I is in line (matched) with orientation DrS of mobile terminal 10. Before lying down, user Ur touches touch screen TS with his/her left index finger and middle finger simultaneously or substantially simultaneously.

Next, referring to FIG. 5B, when user Ur lies down while maintaining the vertically-held state and the two-point simultaneous touch state, it is determined that orientation DrS of mobile terminal 10 has been changed from the vertical orientation to the lateral orientation from the sensing result of inertia sensor 38. At this time, since touch screen TS is sensing the two-point long touch state, display orientation DrI of image I is maintained in line with orientation DrS of mobile terminal 10. Therefore, image I is seen upright for user Ur lying down laterally similarly to touch screen TS.

Next, referring to FIG. 5C, even if user Ur cancels the two-point long touch after lying down, display orientation DrI of image I is maintained in line with orientation DrS of mobile terminal 10. After user Ur lies down, the sensing result of inertia sensor 38 continuously shows that orientation DrS of mobile terminal 10 is the vertical orientation. Image I will not be turned as long as orientation DrS of mobile terminal 10 is maintained in the vertical orientation since turning of image I is executed using a real time change of orientation DrS of mobile terminal 10 as a trigger.

Next, referring to FIG. 5D, user Ur then touches touch screen TS again with his/her left index finger and middle finger simultaneously or substantially simultaneously before trying to rise up, that is, returning to the upright posture from the lying posture.

Next, referring to FIG. 5E, when user Ur then rises up while maintaining the two-point simultaneous touch state, it is determined that orientation DrS of mobile terminal 10 has been changed from the lateral orientation to the vertical orientation from the sensing result of inertia sensor 38. At this time, since touch screen TS is sensing the two-point long touch state, display orientation DrI of image I is maintained at orientation DrS of mobile terminal 10. Therefore, image I is seen upright for user Ur having returned to the upright posture similarly to touch screen TS.

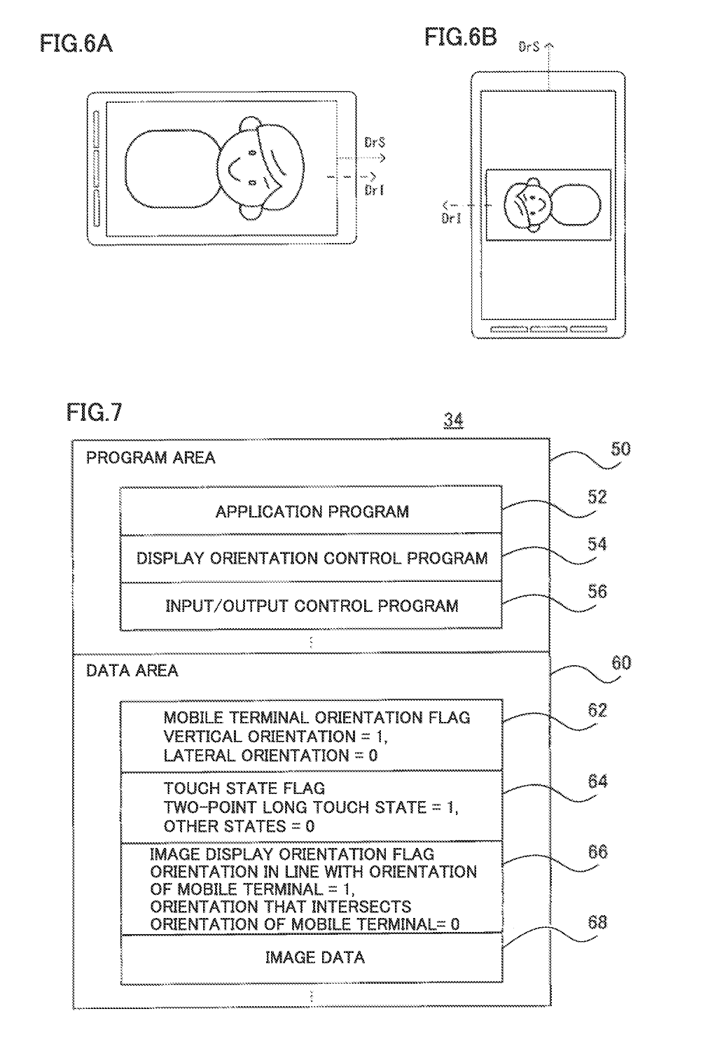

After FIG. 5C, if user Ur does not perform a two-point long touch as shown in FIG. 6A when rising up, display orientation DrI of image I is turned to an orientation that intersects orientation DrS of mobile terminal 10 as shown in FIG. 6B, for example. The result is that image I is seen lying for user Ur having returned to the upright posture similarly to touch screen TS.

The display orientation control in the application processing mode as described above is implemented by CPU 24 executing the process in accordance with the flow shown in FIG. 8 based on the various types of programs (52 to 56) and data (62 to 74) stored in main memory 34 shown in FIG. 7, for example.

Specifically, referring to FIG. 7, main memory 34 includes a program area 50 and a data area 60. An application program 52, a display orientation control program 54, an input/output control program 56, and the like are stored in program area 50. A screen orientation flag 62, a touch state flag 64, an image display orientation flag 66, image data 68, and the like are stored in data area 60.

Although not shown, a various types of control programs for achieving the conversation mode, data communication mode and the like described above are also stored in program area 50.

Application program 52 is a program for causing CPU 24 to execute application processing such as image review. Display orientation control program 54 is a program for controlling display orientation DrI of image I displayed on touch screen TS through the application processing executed by application program 52 based on a sensing result of inertia sensor 38 and a detection result of touch panel 32, and corresponds to the flowchart of FIG. 8.

Input/output control program 56 is a program for mainly controlling the input/output to/from touch screen TS, namely, the input through touch panel 32 and the output to display 30. More specifically, based on a signal from touch panel 32, input/output control program 56 can distinguish between a state where a finger or the like is touching touch panel 32 (touch state) and a state where nothing is touching touch panel 32 (non-touch state). Input/output control program 56 can detect the coordinates of a touch position, namely, touch point P (see FIGS. 4A and 4B). Input/output control program 56 can cooperate with application program 52 to cause display 30 to display an image of an application. Input/output control program 56 can determine orientation DrS of mobile terminal 10 based on a sensing result of inertia sensor 38.

In particular, touch panel 32 of an embodiment can detect a simultaneous touch on at least two points. Input/output control program 56 can distinguish among a tap operation, a double tap operation, a long touch operation on one point, a sliding operation, a flick operation, and a pinching operation based on the touch coordinates of one point detected or two points simultaneously detected by touch panel 32, or changes thereof. Input/output control program 56 can distinguish between such existing touch operations and a long touch operation on two points for forbidding turning with the change of orientation DrS of mobile terminal 10 as described above.

Screen orientation flag 62 is a flag indicating orientation DrS of mobile terminal 10. Screen orientation flag 62 may be controlled by input/output control program 56 between “1” indicating the vertical orientation (the orientation opposite to the direction of gravity) and “0” indicating the lateral orientation (the orientation perpendicular to the direction of gravity) based on a sensing result of inertia sensor 38.

Touch state flag 64 is a flag indicating a state of a touch on touch screen TS. Touch state flag 64 may be controlled by input/output control program 56 between “1” indicating a two-point long touch state and “0” indicating a state other than a two-point long touch (a non-touch state and a normal touch state such as a one-point long touch) based on an output of touch panel 32.

Image display orientation flag 66 is a flag indicating display orientation DrI of image I with respect to touch screen TS. Image display orientation flag 66 may be controlled by display orientation control program 54 between “1” indicating the orientation in line with (parallel or substantially parallel to) touch screen TS and “0” indicating the orientation that intersects (perpendicular or substantially perpendicular to) touch screen TS.

Image data 68 is image data of image I indicating a target or a result of application processing. Image data 68 is written into data area 60 by application program 52, and then read from data area 60 by input/output control program 56 under the control of display orientation control program 54 for supply to driver 28. Accordingly, image I may be displayed on display 30 in modes as shown in FIGS. 4A to 5E.

For example, in FIG. 4B, image I has been turned 90 degrees with respect to touch screen TS and resized to fit the width of touch screen TS. Such a display mode (laterally-held display mode) is achieved by, for example, changing the reading direction and performing thinning-out reading when reading image data 68 from data area 60 for supply to driver 28.

FIG. 8 shows a flowchart of a display orientation control process executed by CPU 24. FIG. 9 shows transitions of various flags (62 to 66) stored in main memory 34. The flow of FIG. 8 and flag transitions in FIG. 9 correspond to the changes in display mode between FIGS. 4A and 4B, among 5A to 5E, and between 6A and 6B.

When a posture change of mobile terminal 10 is sensed by inertia sensor 38, the flow of FIG. 8 starts. At first, in step S1, CPU 24 can determine based on touch state flag 64 whether or not the state of touch screen TS is a two-point long touch state. If touch state flag 64 is “0”, it is determined as NO in step S1 (a state other than a two-point long touch state), and the process proceeds to step S3. If touch state flag 64 is “1”, it is determined as YES in step S1 (a two-point long touch state), and the process proceeds to step S5.

In step S3, CPU 24 can switch display orientation DrI of image I with respect to touch screen TS by changing the value of image display orientation flag 66. This flow is then terminated. In step S5, this flow is terminated without executing such switching of display orientations.

If a two-point long touch operation is not being performed at the time when a posture change is sensed, switching of display orientations may be executed. If a two-point long touch operation is being performed at the time when a posture change is sensed (in other words, even if touch screen TS is changed to the lateral orientation during a two-point long touch operation), switching of display orientations is not executed. Even if the two-point long touch operation is canceled after the posture change, the display orientation will not be switched until a next posture change is sensed.

Specifically, referring to FIG. 9 as well, the vertically-held display mode as shown in FIG. 4A is expressed by screen orientation flag 62 of “1” (a state where orientation DrS of mobile terminal 10 is the vertical orientation), touch state flag 64 of “0” (a state where touch screen TS is in an operation other than a two-point long touch), and image display orientation flag 66 of “1” (a state where display orientation DrI of image I is in line with orientation DrS of mobile terminal 10).

When the vertically-held use is changed to the laterally-held use (or when user Ur lies down without a two-point long touch operation), screen orientation flag 62 is changed from “1” to “0” (the state where orientation DrS of mobile terminal 10 is lateral). This triggers the flow of FIG. 8 to start. Since touch state flag 64 remains at “0”, CPU 24 determines as NO in step S1, and switches image display orientation flag 66 from “1” to “0”. This achieves switching to the laterally-held display mode as shown in FIG. 4B.

The display mode before a user lies down while performing a two-point long touch with the mobile phone held vertically as shown in FIG. 5A is expressed by screen orientation flag 62 of “1”, touch state flag 64 of “1” (where touch screen TS is in a two-point long touch state), and image display orientation flag 66 of “1”.

When user Ur lies down, screen orientation flag 62 is changed from “1” to “0”, and this triggers the flow of FIG. 8 to start. Since touch state flag 64 remains at “1”, CPU 24 determines as YES in step S1, and the process proceeds to step S5 where image display orientation flag 66 is maintained at “1”. Forbiddance of turning of display orientation DrI of image I thereby works, and a display mode as shown in FIG. 5B suitable for user Ur lying down as shown in FIG. 3B to see is achieved.

After lying down (i.e., in the state lying down), the two-point long touch may be canceled as shown in FIG. 5C. When the two-point long touch is canceled while a user is lying down, touch state flag 64 is changed from “1” to “0”, but screen orientation flag 62 remains at “0”. Thus, the flow of FIG. 8 will not be started again. Image display orientation flag 66 is therefore maintained at “1”, and orientation DrI of image I will not be changed.

If a two-point long touch operation is performed as shown in FIGS. 5D and 5E also when rising up after lying down, turning of image I with the posture change can be stopped. When user Ur rises up while performing a two-point long touch, screen orientation flag 62 is changed from “0” to “1”, and the flow of FIG. 8 is started again. In this case, since touch state flag 64 is “1”, the determination in step S1 results in YES. The process proceeds to step S5, and image display orientation flag 66 is also maintained at “1”. As a result, image I is seen upright for user Ur without orientation DrI of image I being switched.

If a user does not perform a two-point long touch when rising up, turning of image I with the posture change as shown in FIGS. 6A and 6B, for example, will take place. Specifically, when user Ur rises up without performing a two-point long touch on touch screen TS, screen orientation flag 62 is changed from “0” to “1”, and the flow of FIG. 8 is started again. In this case, since touch state flag 64 is “0”, the determination in step S1 results in NO. The process proceeds to step S3, and image display orientation flag 66 is changed from “0” to “1”. As a result, display orientation DrI of image I is switched, and image I is seen lying for user Ur.

As is clear from the foregoing, in an embodiment, mobile terminal 10 has touch screen TS that can display image I and can receive a touch operation relevant to image I, and inertia sensor 38 configured to sense a change of orientation DrS of mobile terminal 10.

CPU 24 of such mobile terminal 10 performs the following processing under the control of display orientation control program 54 stored in main memory 34. When orientation DrS of mobile terminal 10 is changed, it is determined whether or not a two-point long touch operation is being performed on touch screen TS (S1). If it is determined that a two-point long touch operation is not being performed, display orientation DrI of image I can be turned based on the sensing result of inertia sensor 38 (NO in S1, then S3). Therefore, when user Ur changes the posture of mobile terminal 10 (laterally held/vertically held), display orientation DrI of image I is turned. The state where image I is seen upright for user Ur can thus be maintained.

If it is determined that a two-point long touch operation is being performed, turning of display orientation DrI of image I based on the sensing result of inertia sensor 38 can be forbidden (YES in S1, then S5). Therefore, when user Ur wishes to see image I while lying down, turning of display orientation DrI of image I based on the sensing result of inertia sensor 38 is forbidden if he/she lies down while performing a two-point long touch operation. Poor visibility that image I is seen lying for user Ur can be solved.

According to an embodiment, since turning of display orientation DrI of image I can be forbidden if user Ur lies down while performing a two-point long touch operation, he/she does not need to perform an operation such as mode switching before lying down. The visibility and operability when seeing an image while lying down can thereby be improved.

If it is determined that a two-point long touch operation is being performed, CPU 24 can forbid turning of display orientation DrI of image I based on the sensing result of inertia sensor 38 until orientation DrS of mobile terminal 10 is changed next time. Since turning of display orientation DrI of image I based on the sensing result of inertia sensor 38 is forbidden until orientation DrS of mobile terminal 10 is changed next time, display orientation DrI of image I will not be turned even if user Ur cancels the two-point long touch operation after lying down unless he/she rises up or changes the posture of mobile terminal 10 (laterally held/vertically held). Since it is not necessary to continue the two-point long touch operation after the action of lying down is completed, a touch operation (e.g., a tap operation, a flick operation, a sliding operation, a pinching operation, etc.) other than a two-point long touch operation can be performed with fingers with which the two-point long touch operation has been performed.

In the above-described embodiment, when user Ur rises up without performing a two-point long touch operation and turning of image I as shown in FIGS. 6A and 6B takes place, a resetting operation for returning the display mode of FIG. 6B to the display mode of FIG. 4A (i.e., aligning display orientation DrI of image I with orientation DrS of mobile terminal 10) or the like may be required, which is troublesome.

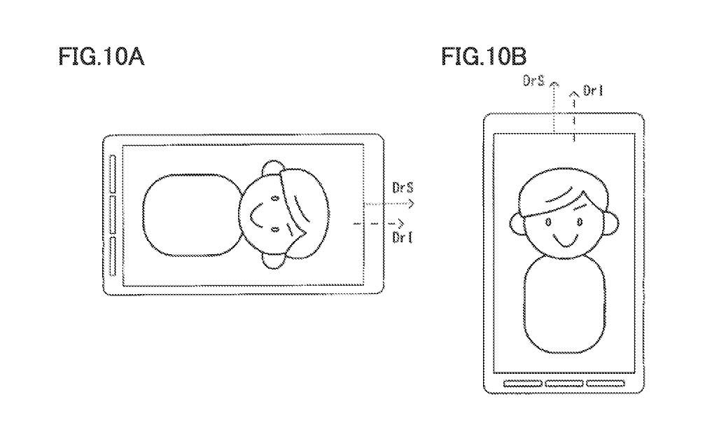

In this respect, a variation which will be described below effects control such that turning of image I is stopped even if user Ur rises up without performing a two-point long touch operation, as shown in FIGS. 10A and 10B.

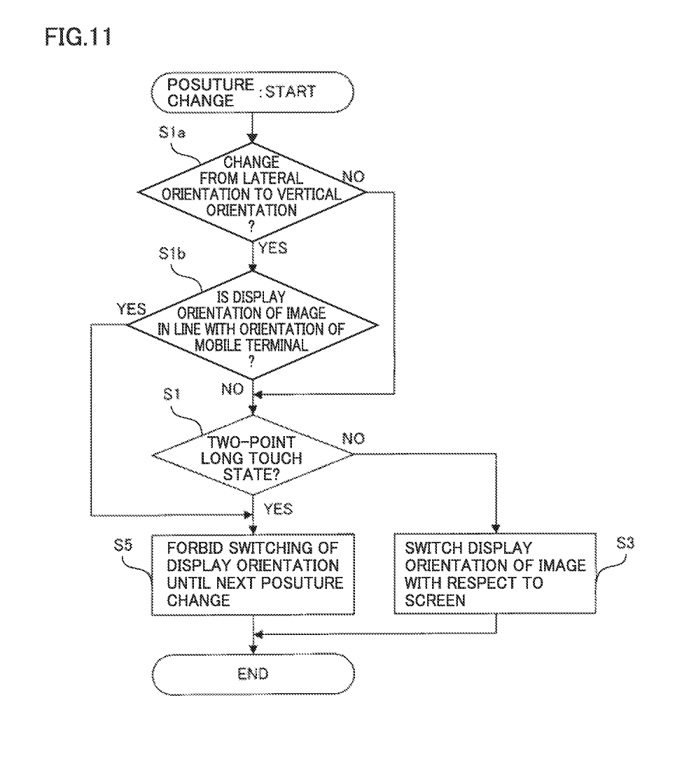

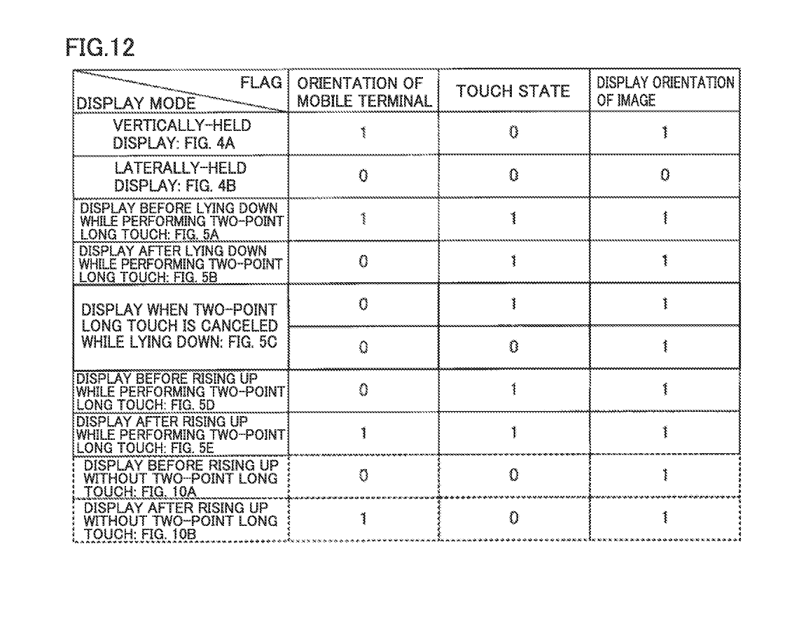

FIG. 11 is a flowchart showing a display orientation control process in a variation. FIG. 12 shows transitions of various flags (62 to 66) in this variation. The flow of FIG. 11 and the flag transitions of FIG. 12 correspond to the change in display mode between FIGS. 4A and 4B, among FIGS. 5A to 5E, and between FIGS. 10A and 10B.

The flow of FIG. 11 is obtained by adding steps S1a and S1b to the flow of FIG. 8. Sensing of a posture change triggers the flow to start, similarly to the flow of FIG. 8. When a posture change is sensed, at first, CPU 24 in step S1a determines whether or not the posture change is a change from the lateral orientation to the vertical orientation. If it is YES in step S1a (a change from the lateral orientation to the vertical orientation), the process proceeds to step S1b, and if it is NO in step S1a (a change from the vertical orientation to the lateral orientation), the process proceeds to step S1.

In step S1b, it is determined whether or not display orientation DrI of image I is in line with orientation DrS of mobile terminal 10 (typically, in the same or substantially same orientation with each other). If it is determined as YES in step S1b (orientation DrS of mobile terminal 10 and display orientation DrI of image I are matched), the process proceeds to step S5. If it is determined as NO in step S1b (display orientation DrI of image I intersects orientation DrS of mobile terminal 10), the process proceeds to step S1. The processing executed in steps S3 and S5 is similar to that described above, and description thereof is omitted here.

First, when user Ur lies down, it is determined as NO in step S1a and the process proceeds to step S1. Similar processing to that of the flow of FIG. 8 will thus be executed.

Next, when user Ur rises up, it is determined as YES in step S1a, and the process proceeds to step S1b, where it is determined whether or not display orientation DrI of image I is in line with orientation DrS of mobile terminal 10, that is, whether orientation DrS of mobile terminal 10 is in line with or intersects orientation DrS of mobile terminal 10. If display orientation DrI of image I is in line with orientation DrS of mobile terminal 10, step S5 is executed skipping step S1 (determination as to whether or not it is in a two-point long touch state). Whether user Ur rises up while performing a two-point long touch operation as shown in FIGS. 5D and 5E or rises up without performing a two-point long touch operation as shown in FIGS. 10A and 10B, turning of display orientation DrI of image I is forbidden, and the state where image I is seen upright for user Ur can be maintained.

If display orientation DrI of image I intersects (typically, perpendicular or substantially perpendicular to) orientation DrS of mobile terminal 10, the process proceeds to step S1, and processing similar to that of the flow of FIG. 8 is executed. The state where image I is seen upright for user Ur can also be maintained when user Ur returns mobile terminal 10 from the laterally-held use as shown in FIG. 4B to the vertically-held use as shown in FIG. 4A while remaining standing.

If a two-point long touch operation is performed when returning mobile terminal 10 from the laterally-held use to the vertically-held use, turning of image I with the posture change is forbidden, with the result that a change will be made as shown in FIG. 4B to FIG. 6B. Although a resetting operation might also be required in this case, it is usually hard to consider performing a two-point long touch operation by mistake when returning mobile terminal 10 from the laterally-held use to the vertically-held use, which will not particularly become a problem.

As is clear from the foregoing, in this variation, CPU 24 can determine whether display orientation DrI of image I is in line with or intersects orientation DrS of mobile terminal 10 when the change of orientation DrS of mobile terminal 10 is the change from the lateral orientation to the vertical orientation (YES in S1a, then S1b). If it is determined that display orientation DrI of image I is in line with orientation DrS of mobile terminal 10, turning of display orientation DrI of image I can be forbidden, regardless of whether or not a two-point long touch operation is being performed on touch screen TS (YES in S1b, then S5). The expression that display orientation DrI of image I “is in line with” orientation DrS of mobile terminal 10 refers to the state where display orientation DrI of image I and orientation DrS of mobile terminal 10 are identical or substantially identical (parallel or substantially parallel) to each other, and the word “intersects” refers to the state where display orientation DrI of image I and orientation DrS of mobile terminal 10 are perpendicular or substantially perpendicular to each other.

In the above-described embodiment, when user Ur lies down while performing a two-point long touch operation and then rises up, if he/she rises up without performing a two-point long touch operation, display orientation DrI of image I might be turned, and image I might be seen lying for user Ur (FIG. 6A to FIG. 6B). In this variation, whether user Ur rises up while performing a two-point long touch operation (FIG. 5D to FIG. 5E), or whether user Ur rises up without performing a two-point long touch operation (FIG. 10A to FIG. 10B), image I will not be seen lying for user Ur since turning of display orientation DrI of image I is forbidden. Therefore, a resetting operation for aligning display orientation DrI of image I with orientation DrS of mobile terminal 10, which will be required in an embodiment when user Ur rises up without performing a two-point long touch operation, and the like are unnecessary in the variation. Visibility and operability are thus improved further.

When the change of the orientation of mobile terminal 10 is the change from the vertical orientation to the lateral orientation, CPU 24 can determine whether or not a two-point long touch operation is being performed on touch screen TS, regardless of whether display orientation DrI of image I is in line with or intersects orientation DrS of mobile terminal 10 (NO in S1a, then S1). When user Ur lies down, CPU 24 determines whether or not a two-point long touch operation is being performed, regardless of whether display orientation DrI of image I is in line with or intersects orientation DrS of mobile terminal 10. A change can be made from the vertically-held display mode to the laterally-held display mode (FIG. 4A to FIG. 4B), or the display mode after rising up without performing a two-point long touch operation can be returned to the display mode before rising up (FIG. 6B to FIG. 6A).

The change of orientation DrS of mobile terminal 10 is the change from the lateral orientation to the vertical orientation, and if it is determined that display orientation DrI of image I intersects orientation DrS of mobile terminal 10, CPU 24 can determine whether or not a two-point long touch operation is being performed on touch screen TS (YES in S1a, NO in S1b, then S1). CPU 24 determines whether or not a two-point long touch operation is being performed on touch screen TS if display orientation DrI of image I intersects orientation DrS of mobile terminal 10 when user Ur rises up. Depending on whether or not a two-point long touch operation is being performed, the laterally-held display mode can be changed to the vertically-held display mode (FIG. 4B to FIG. 4A), or the laterally-held display mode can be maintained even if the mobile phone is changed to the vertically-held state (FIG. 4B to FIG. 6B).

Accordingly, when user Ur lies down or rises up, various types of display orientation control can be performed utilizing a two-point long touch operation.

Although turning of image I is forbidden by a two-point long touch operation in an embodiment or a variation, a touch operation for forbidding turning of image I may be any touch operation as long as it is distinguishable from any of touch operations usually used in mobile terminal 10 (e.g., a tap operation, a double tap operation, a long touch operation on one point, a sliding operation, a flick operation, a pinching operation, and the like).

Although the foregoing describes the display orientation control in the application processing mode as an example, display orientation control of the same type may also be performed in the data communication mode or another mode.

Typically, mobile terminal 10 of an embodiment and a variation is a smartphone, but may be any mobile terminal (e.g., a tablet PC, a personal digital assistant, a mobile phone, etc.) as long as it has an inertia sensor (an accelerometer, a gyroscope, etc.), a touch screen (a liquid crystal display with a touch panel, etc.), and a computer (CPU, a memory, etc).

A mobile terminal according to a first embodiment includes a touch screen, a sensor, a storage unit, and at least one processor configured to execute a control program stored in the storage unit. The touch screen is configured to display an image and receive a touch operation relevant to the image. The sensor is configured to sense a change of an orientation of the mobile terminal. When the sensor senses the change of the orientation of the mobile terminal, the at least one processor is configured to determine whether or not a specific touch operation is being performed on the touch screen. When it is determined that the specific touch operation is not being performed, the at least one processor is configured to turn a display orientation of the image based on a sensing result of the sensor. When it is determined that the specific touch operation is being performed, the at least one processor is configured not to turn the display orientation of the image.

In the first embodiment, the mobile terminal (10) has a touch screen (TS: 30, 32) displaying an image (I) and being capable of receiving a touch operation relevant to the image, and a sensor (38) sensing a change of an orientation (DrS) of the mobile terminal. The “orientation of the mobile terminal” refers to the orientation from the central point (P0) of the lower edge of the touch screen to the central point (P1) of the upper edge, for example.

In such a mobile terminal, the display orientation control process executed by the at least one processor are implemented by the computer (24) executing a display orientation control program (54) stored in the memory (34). When the sensor senses the change of the orientation of the mobile terminal, the at least one processor is configured to determine whether or not a specific touch operation is being performed on the touch screen (S1). When it is determined that the specific touch operation is not being performed, the at least one processor is configured to turn a display orientation of the image based on a sensing result of the sensor (NO in S1, then S3). When a user changes the posture of the mobile terminal (laterally held/vertically held) without performing the specific touch operation, the display orientation of an image is turned. The state where the image is seen upright for a user can thus be maintained.

When it is determined that the specific touch operation is being performed, the at least one processor is configured not to turn the display orientation of the image (YES in S1, then S5). When a user (Ur) wishes to see an image while lying down, turning of the display orientation of the image based on the sensing result of the sensor is forbidden if he/she lies down while performing the specific touch operation, which can solve poor visibility that an image is seen lying for a user.

According to the first embodiment, turning of the display orientation of the image can be forbidden merely by a user lying down while performing a specific touch operation. This eliminates the necessity to perform an operation such as mode switching before lying down, which improves visibility and operability when seeing an image while lying down.

A second embodiment depends on the first embodiment, and, when it is determined that the specific touch operation is being performed, the at least one processor is configured not to turn the display orientation of the image until the orientation of the mobile terminal is changed next time.

According to the second embodiment, turning the display orientation of the image is forbidden until the orientation of the mobile terminal is changed next time. Even if a user cancels the specific touch operation after he/she lies down, the display orientation of an image will not be turned unless he/she rises up or changes the posture of the mobile terminal (laterally held/vertically held). Since it is not necessary to continue the specific touch operation after the action of lying down is completed, a touch operation (e.g., a tap operation, a flick operation, a sliding operation, a pinching operation, etc.) other than the specific touch operation can be performed with a finger with which the specific touch operation has been performed.

A third embodiment depends on the first embodiment, and the at least one processor is further configured to, when the change of the orientation of the mobile terminal is a change from a lateral orientation to a vertical orientation, determine whether the display orientation of the image is in line with or intersects the orientation of the mobile terminal. When it is determined that the display orientation of the image is in line with the orientation of the mobile terminal, the at least one processor is configured not to turn the display orientation of the image regardless of whether or not the specific touch operation is being performed on the touch screen.

In the third embodiment, the determination of the display orientation is further achieved. When the change of the orientation of the mobile terminal is a change from the lateral orientation to the vertical orientation, the display orientation determination module is configured to determine whether the display orientation of the image is in line with or intersects the orientation of the mobile terminal (YES in S1a, then S1b). When it is determined that the display orientation of the image is in line with the orientation of the mobile terminal, the at least one processor is configured not to turn the display orientation of the image regardless of whether or not the specific touch operation is being performed on the touch screen (YES in S1b, then S5). The expression that the display orientation of an image “is in line with” the orientation of the mobile terminal refers to the state where the display orientation of an image and the orientation of the mobile terminal are identical or substantially identical (parallel or substantially parallel) to each other, and the word “intersects” refers to the state where the display orientation of an image and the orientation of the mobile terminal are perpendicular or substantially perpendicular to each other.

In the first or second embodiment, when a user lies down while performing a specific touch operation and then rises up, if he/she rises up without performing the specific touch operation, the display orientation of an image might be turned, and the image might be seen lying for the user (FIG. 6A to FIG. 6B). According to the third embodiment, forbiddance of turning of the display orientation of an image works even if a user rises up while performing the specific touch operation (FIG. 5D to FIG. 5E) or even if a user rises up without performing the specific touch operation (FIG. 10A to FIG. 10B). Thus, the image will not be seen lying for the user. A resetting operation for aligning the orientation of the screen with the display orientation of an image, which is required in the first or second embodiment when a user rises up without performing a specific touch operation, is unnecessary in the third embodiment. Visibility and operability are thus improved further.

A fourth embodiment depends on the first embodiment, and, when the change of the orientation of the mobile terminal is a change from the vertical orientation to the lateral orientation, the at least one processor is configured to determine whether or not the specific touch operation is being performed on the touch screen regardless of whether the display orientation of the image is in line with or intersects the orientation of the mobile terminal (NO in S1a, then S1).

In the fourth embodiment, when a user lies down, it can be determined whether or not the specific touch operation is being performed on the touch screen regardless of whether the display orientation of the image is in line with or intersects the orientation of the mobile terminal. A change can be made from the vertically-held display mode to the laterally-held display mode (FIG. 4A to FIG. 4B), or the display mode after rising up without performing the specific touch operation can be returned to the display mode before rising up without performing a specific touch operation (FIG. 6B to FIG. 6A).

A fifth embodiment depends on the third embodiment, and, when the change of the orientation of the mobile terminal is a change from the lateral orientation to the vertical orientation, and when it is determined that the display orientation of the image intersects the orientation of the mobile terminal, the at least one processor is configured to determine whether or not the specific touch operation is being performed on the touch screen (YES in S1a, NO in S1b, then S1).

In the fifth embodiment, if the display orientation of the image intersects the orientation of the mobile terminal when a user rises up, it can be determined whether or not the specific touch operation is being performed on the touch screen. Depending on whether or not the specific touch operation is being performed, a change can be made from the laterally-held display mode to the vertically-held display mode (FIG. 4B to FIG. 4A), or the laterally-held display mode can be maintained even if the mobile terminal is changed to the vertically-held state (FIG. 4B to FIG. 6B).

According to the fourth and fifth embodiments, when a user lies down or rises up, various types of display orientation control can be performed utilizing a specific touch operation.

A sixth embodiment depends on the first embodiment, and the specific touch operation includes an operation distinguishable from any of a tap operation, a double tap operation, a long touch operation on one point, a sliding operation, a flick operation, and a pinching operation.

According to the sixth embodiment, the specific touch operation can be used in combination with a general touch operation.

A seventh embodiment depends on the first embodiment, and the specific touch operation includes a long touch operation on at least two points.

According to the seventh embodiment, it is possible to make an intuitive touch operation as if holding an image with two fingers to stop turning of the image.

An eighth embodiment is a display orientation control method for controlling the display orientation of an image displayed on a touch screen of a mobile phone. The touch screen is configured to be capable of displaying an image and receiving a touch operation relevant to the image. The display orientation control method includes a sensing step, a state determination step, a turning step and a non-turning step. The sensing step is configured to sense a change of an orientation of the mobile terminal. When it is sensed that the change of the orientation of the mobile terminal, it is determined in the state determination step whether or not a specific touch operation is being performed on the touch screen. When it is determined in the state determination step that the specific touch operation is not being performed, a display orientation of the image is turned in the turning step based on a sensing result of the sensing step. When it is determined in the state determination step that the specific touch operation is being performed, the display orientation of the image is not turned in the non-turning step.

According to the eighth embodiment, visibility and operability when a user sees an image while lying down are also improved, similarly to the first embodiment.

Although the present disclosure has been described and illustrated in detail, it is clearly understood that the same is by way of illustration and example only and is not to be taken by way of limitation, the scope of the present disclosure being interpreted by the terms of the appended claims.

1. A mobile terminal, comprising:
a touch screen configured to display an image and receive a touch operation relevant to the image;
a sensor configured to sense a change of an orientation of the mobile terminal;
a storage unit configured to store a control program; and
at least one processor configured to execute the control program,
the at least one processor being configured to
determine whether or not a specific touch operation is being performed on the touch screen, when the sensor senses the change of the orientation of the mobile terminal,
turn a display orientation of the image based on a sensing result of the sensor when it is determined that the specific touch operation is not being performed, and
not turn the display orientation of the image when it is determined that the specific touch operation is being performed.

2. The mobile terminal according to claim 1, wherein, when it is determined that the specific touch operation is being performed, the at least one processor is configured not to turn the display orientation of the image until the orientation of the mobile terminal is changed next time.

3. The mobile terminal according to claim 1, the at least one processor further being configured to, when the change of the orientation of the mobile terminal is a change from a lateral orientation to a vertical orientation, determine whether the display orientation of the image is in line with or intersects the orientation of the mobile terminal, wherein
when it is determined that the display orientation of the image is in line with the orientation of the mobile terminal, the at least one processor is configured not to turn the display orientation of the image regardless of whether or not the specific touch operation is being performed on the touch screen.

4. The mobile terminal according to claim 1, wherein, when the change of the orientation of the mobile terminal is a change from the vertical orientation to the lateral orientation, the at least one processor is configured to determine whether or not the specific touch operation is being performed on the touch screen regardless of whether the display orientation of the image is in line with or intersects the orientation of the mobile terminal.

5. The mobile terminal according to claim 3, wherein, when the change of the orientation of the mobile terminal is a change from the lateral orientation to the vertical orientation and when it is determined that the display orientation of the image intersects the orientation of the mobile terminal, the at least one processor is configured to determine whether or not the specific touch operation is being performed on the touch screen.

6. The mobile terminal according to claim 1, wherein the specific touch operation includes an operation distinguishable from any of a tap operation, a double tap operation, a long touch operation on one point, a sliding operation, a flick operation, and a pinching operation.

7. The mobile terminal according to claim 1, wherein the specific touch operation includes a long touch operation on at least two points.

8. A display orientation control method for controlling a display orientation of an image displayed on a touch screen of a mobile terminal, configured to display an image and receive a touch operation relevant to the image, the display orientation control method comprising:
sensing a change of an orientation of the mobile terminal,
determining whether or not a specific touch operation is being performed on the touch screen when the change of the orientation of the mobile terminal is sensed,
turning a display orientation of the image based on a sensing result when it is determined that the specific touch operation is not being performed, and
not turning the display orientation of the image when it is determined that the specific touch operation is being performed.
